(19) United States
(12) Patent Application Publication
(10) Pub. No.: US 2025/0073737 A1
(43) Pub. Date: Mar. 6, 2025

(54) APPARATUS FOR BLACK OXIDE FINISHING

(71) Applicant: AKTIEBOLAGET SKF, GOTEBORG (SE)

(72) Inventors: Xiaoyu ZHANG, Shanghai (CN); Bo SHEN, Jiangyin (CN); Yunfeng SONG, Suzhou (CN)

(21) Appl. No.: 18/810,702

(22) Filed: Aug. 21, 2024

(30) Foreign Application Priority Data
Aug. 29, 2023 (DE) 102023208230.6

(51) Int. Cl. B05B 16/00; B05B 1/14; H05B 6/10

(52) U.S. Cl. CPC B05B 16/00; B05B 1/14; H05B 6/10

(57) ABSTRACT

An apparatus for black oxide finishing a bearing component, such as a bearing ring, includes a holder configured to hold the bearing component, an induction heater having at least one inductor, and a sprayer. The at least one inductor is configured to heat the bearing component while the bearing component is held by the holder, and the spraying device is configured to spray black oxide fluid onto the heated bearing component while the heated bearing component is held by the holder in order to form a black oxide finish on the bearing component.

### CROSS-REFERENCE

This application claims priority to German patent application no. 10 2023 208 230.6filed on Aug. 29, 2023, the contents of which are fully incorporated herein by reference.

### TECHNOLOGICAL FIELD

The present disclosure is directed to a method and apparatus for black oxide finishing a bearing component, and more specifically, to a method and apparatus for black oxide finishing a component without immersing the component in a black oxide fluid.

### BACKGROUND

In recent years, black oxide finishing or coating has become a very important coating in several technical applications, for example in wind turbine applications. Black oxide finishing may serve as corrosion protection of surfaces of bearing components, for example surfaces of bearings rings. At present, when black oxide finishing large-size rings having a diameter of less than 2.5 meters, a traditional full immersion or partial immersion black oxide process may be used. During such an immersion process, the ring or any other bearing component is preferably completely immersed into a black oxide fluid, for example a tank comprising the black oxide fluid. During immersion of the ring into the black oxide fluid, the ring is heated by means of the temperature of the black oxide fluid. For a proper chemical reaction between the black oxide fluid and the surface of the ring, the temperature of the ring surface being treated must be similar to the temperature of the black oxide fluid. During the chemical reaction, the surface of the ring reacts with the black oxide fluid, which leads to a conversion layer, called the black oxide layer. When the surface of the ring is too cold, the black oxide fluid may not react sufficiently with the surface of the ring, resulting in an insufficient black oxide coating.

When the diameter of the rings is greater than 2.5 meters, or even greater than 3.0meters, due to the significant increase in size and weight, the volume of the corresponding black oxide tank and fluid needs to match the increased size of the ring and thus increases also significantly. This results in an increased floor area and height of the whole production line. Further, when the rings are heated by the traditional way of heat exchange between the bath fluid and the material of the ring, for example steel, the heating of the ring is slow in terms of heating speed and has a low efficiency. Thus, when a large ring needs to be black oxide coated and the ring needs to be heated by the black oxide fluid, this may result in a large amount of evaporation of the black oxide fluid from the tank and/or may cool down the black oxide fluid which then needs to be reheated, resulting in high energy consumption.

### SUMMARY

It is therefore an aspect of the present disclosure to provide an improved method for black oxide finishing large bearing components.

An apparatus for black oxide finishing a bearing component, in particular a bearing ring but also any other component of a rolling or plain bearing, comprises a holding device, sometimes referred to as a “holder,” configured to hold the bearing component. The holding device may comprise for example several holding elements, for example brackets, clips, clamps, cramps, or the like, which are able to hold the bearing component.

In order to black oxide coat or finish the bearing component without the need to fully immerse the bearing component into a black oxide fluid, the apparatus comprises a spraying device, sometimes referred to as a “sprayer,” configured to spray black oxide fluid onto the heated bearing component. The black oxide fluid may be contained in a tank or reservoir with which the spraying device may be connected, for example via pipes or tubes, for supplying the black oxide fluid from the tank to outlets of the spraying device and then onto the bearing component.

As the bearing component is in this case only insufficiently heated by the black oxide spray, the apparatus further comprises an induction heating device having at least one inductor configured to heat the bearing component. Because the inductor heats the bearing component, or at least a surface of the bearing component, the black oxide fluid is sprayed onto a surface of the bearing component that has a temperature sufficiently high to react with the black oxide fluid. For example, the surface may be heated to have a temperature which is equal to or at least close to the temperature of the black oxide fluid. The temperature of the black oxide fluid is typically about 140° C. or higher. For example, the bearing component may be heated to a temperature between 50 and 150° C., particularly to a temperature between 110 and 145° C.

Spraying the black oxide fluid onto the bearing component instead of immersing the bearing component into the black oxide fluid has the advantages that a) less fluid may be needed, b) less space is required (because no large tanks are needed for containing the black oxide fluid) and c) energy may be saved (because the black oxide fluid does not need to be continuously heated and does not loose temperature and require reheating when a cold bearing component is immersed). Further, the described apparatus has the advantage that it may be easily adapted to different sizes of the bearing component. For example, the holding device may be configured to hold different sizes of bearing components. The spraying device may also be arranged variable or may be adjusted to be able to spray black oxide fluid to different sizes of bearing components. Thus, the apparatus provides a variable and flexible way of black oxide finishing a bearing component, which is economically efficient.

According to an embodiment, the holding device comprises a rotatable component for rotating the bearing component so that the all relevant surface portions of the bearing component pass the at least one inductor and the spraying device. Preferably, the bearing component is rotated such that it can be treated (heated and sprayed) uniformly. The rotation of the bearing component may be in a vertical or horizontal direction. In particular, the holding device may hold a bearing ring arranged with its rotational axis perpendicular to a horizontal or vertical plane and may be rotated around its rotational axis. Preferably, the holding device, the rotatable component and the bearing component are placed horizontally.

As the bearing component may be rotated according to this embodiment, only one inductor and one spraying device maybe needed because the bearing component rotates and passes the inductor and spraying device. Of course, more than one spraying device and/or more than one inductor may be used which may enhance heating of the bearing component as well as the deposition of the black oxide fluid on the heated bearing component, thus improving the black oxide finishing of the bearing component.

According to a further embodiment, a collecting basin is arranged below the spraying device for collecting excess black oxide fluid, particularly after the chemical reaction with the bearing component. When the black oxide fluid is sprayed onto the bearing component, excess black oxide fluid may drip down from the bearing component. The excess black oxide may be guided back to the black oxide fluid tank and may then be reused. Alternatively, the excess black oxide fluid may be disposed and possibly be recycled.

According to a further embodiment, the holding device, the spraying device, and the induction heating device are arranged above or within a container, wherein the container is configured to collect excess black oxide fluid particularly after the chemical reaction with the bearing component. In addition to collecting black oxide fluid which drips down, such a container may be used for collecting black oxide fluid which is evaporated or sputtered into the environment in the vicinity of the bearing component and the spraying device. Such evaporated or sputtered black oxide fluid may impact onto the side walls of the container and may drip down onto the bottom. On the bottom of the container, the black oxide fluid may be collected, and potentially be reused or disposed, similar to the collecting basin as described above.

According to a further embodiment, the spraying device comprises at least one spray nozzle configured to provide a jet of black oxide fluid for wetting the whole the bearing component and/or for wetting one surface of the bearing component. The type of spray nozzles may be chosen to provide a large flow of black oxide fluid so that the surface of the bearing component is continuously wetted with black oxide fluid. This has the advantage that the surface of the bearing component does not become dry or have water film breaks due to the hot bearing component (which may lead to a defective black oxide layer).

Depending on the arrangement of the spray nozzle, and for example the number of spray nozzles, more or less of the surface of the bearing component may be sprayed with black oxide fluid. The spray nozzle(s) may be adjusted to spray the black oxide fluid in the form of a jet or a drizzle onto the surface of the bearing component. Using a jet form may have the advantage of applying the black oxide fluid at a specific, defined location of the bearing component, whereas using a drizzle may provide the advantage of providing the black oxide fluid onto a broader area of the bearing component at once. In a more specific embodiment, the spray nozzle(s) may be configured to provide a fluid jet in the form of a sheet of fluid or a waterfall, wherein the holding device is configured to move the bearing component to pass the waterfall of black oxide fluid. In this case, the black oxide fluid may be applied particularly uniformly onto the surface of the bearing component. The spray flow should not be too low because that may cause excessive imbalance in the concentration and ratio of black oxide fluid.

Further, the spraying device and/or the spray nozzles may be used for cleaning the bearing component. For example, before applying the black oxide fluid, the bearing component may be cleaned by spraying water or solvent onto the bearing component. After the application of black oxide fluid, water may be sprayed onto the bearing component via the spraying device and/or spray nozzles for cleaning the bearing component and removing the black oxide fluid. In such a case, the spraying device and/or spray nozzles may be coupled either with a tank comprising black oxide fluid or with a water and/or solvent supply pipe. Such a pipe may be connected to a tank or the like containing water and/or a solvent.

According to a further embodiment, the at least one inductor is arranged before the spray nozzle in a rotation direction of the bearing component in order to heat the bearing component before the black oxide fluid is sprayed onto the bearing component. This arrangement has the advantage that the portion of the bearing component, which will be wetted with the black oxide fluid, may be heated immediately before the black oxide fluid is applied. Thus, it may be ensured that the surface of the bearing component has the appropriate temperature for reacting with the black oxide fluid. Further, due to the arrangement of the inductor and the spray nozzle in close proximity, it may be avoided that the bearing component, or the surface of the bearing component, cools down too much in which case it would be no longer possible to guarantee a proper reaction between the bearing component and the black oxide fluid. Alternative, the bearing component as a whole may be first heated using the induction heating device and then the spraying device may start to apply black oxide fluid to the surface of the whole bearing component to have a chemical reaction for forming the black oxide layer.

According to a further embodiment, the spraying device comprises a plurality of spray nozzles arranged around the bearing component to uniformly spray black oxide fluid onto the bearing component. As already described above, the spraying device may comprise more than one spray nozzle. When more than one spray nozzle is used, the time needed for black oxide finishing the bearing component may be reduced. Further, the deposition of the black oxide fluid may be more uniformly, thus improving the distribution of the coating.

According to a further embodiment, the inductor is adapted to the form of the bearing component. This may provide a uniform heating of the bearing component because all portions of the inductor near the bearing component may have the same distance to the bearing component. The inductor may for example be arranged around the bearing component.

According to a further aspect, a method for black oxide finishing of a bearing component, in particular a bearing ring, is provided. The method comprises holding the bearing component and inductively heating the bearing component and spraying black oxide fluid onto the heated bearing component.

According to a further embodiment, the bearing component may be heated before or after the application of the black oxide layer (including heating the bearing component for this application) for temperature pretreatment or posttreatment of the bearing component. This may provide the advantage that the same apparatus and method, which is used for black oxide finishing of the bearing component, may also be used for other temperature treatments. In this case, no black oxide fluid might be sprayed onto the bearing component and the bearing component may only be heated to the correspond pretreatment or posttreatment temperature.

### BRIEF DESCRIPTION OF THE DRAWING

In the following, preferred embodiments of the invention are described in relation to the drawing, wherein the drawing is exemplarily only, and is not intended to limit the scope of protection. The scope of protection is defined by the accompanying claims.

FIG. 1 is a schematic illustration of an apparatus for black oxide finishing a bearing component according to an embodiment of the present disclosure.

### DETAILED DESCRIPTION

In the following same or similar functioning elements are indicated with the same reference numerals.

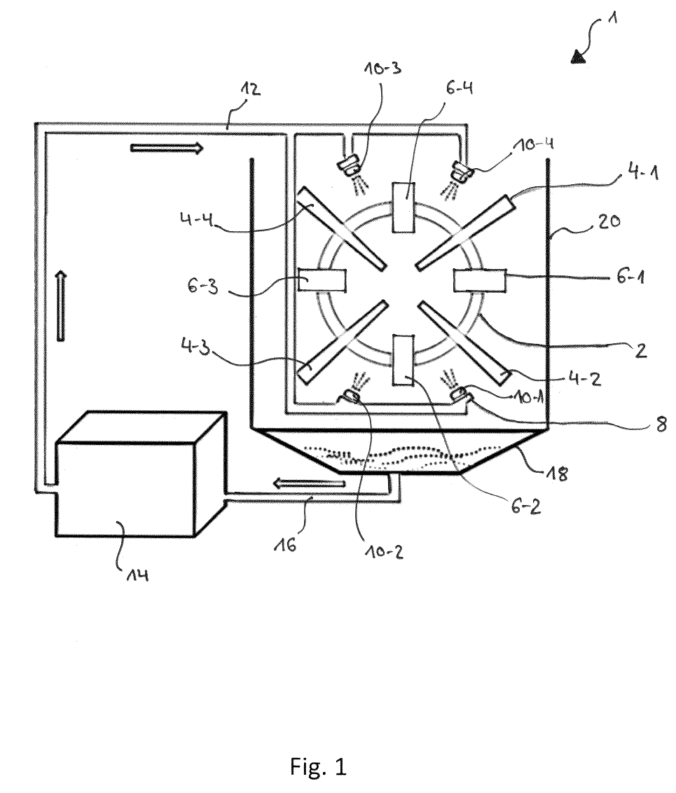

FIG. 1 shows an apparatus 1 for black oxide finishing a bearing component 2. In the illustrated embodiment, the bearing component 2 is shown as a bearing ring; however, it should be noted that the bearing component 2 may also be any other kind of bearing component, for example a sleeve which may serve as an inner ring of a rolling or plain bearing.

The bearing component 2 is held by a holding device which may include one or more holding elements 4-1, 4-2, 4-3, 4-4. The holding elements 4-1, 4-2, 4-3, 4-4 may have any form which is suitable for holding the bearing component 2 and may comprise brackets, support rollers or the like. In addition, the holding elements 4-1, 4-2, 4-3, 4-4 may act as a rotating device, e.g., for rotating the bearing component 2 around its rotational axis. Preferably, both the holding device and the bearing component 2 are placed horizontally. However, other orientations are also possible.

Before the bearing component 2 can be black oxide finished, the bearing component 2 needs to reach a temperature which is suitable for reacting with a black oxide fluid. For this purpose, the apparatus 1 comprises an induction heating device which may have one or more inductors 6-1, 6-2, 6-3, 6-4. The inductors 6-1, 6-2, 6-3, 6-4 may be coils and may be configured to heat the bearing component 2 via an inductive coupling.

In the illustrated embodiment, the apparatus 1 comprises four holding elements 4-1, 4-2, 4-3, 4-4 and four inductors 6-1, 6-2, 6-3, 6-4. However, it should be noted that the apparatus 1 may comprises more or less than the shown four holding elements 4-1, 4-2, 4-3, 4-4 and four inductors 6-1, 6-2, 6-3, 6-4 and that the number of inductors and holding elements may also be different from each other.

When the bearing component 2, or at least a portion of the bearing component 2, is heated to a temperature which is suitable for a proper reaction between the material of the bearing component 2 and the black oxide fluid, the black oxide fluid may be sprayed onto the bearing component 2 via a spraying device 8.

The spraying device 8 may comprise one or more spray nozzles 10-1, 10-2, 10-3, 10-4, four of which are exemplarily shown, for spraying black oxide fluid onto the bearing component 2. The spray nozzles 10-1, 10-2, 10-3, 10-4 may be arranged around the circumference of the bearing component 2 to provide a uniform spray of black oxide fluid onto the bearing component.

The spray nozzles 10-1, 10-2, 10-3, 10-4 may be coupled via a pipe or tube 12 to a tank 14. The tank 14 contains the black oxide fluid. Under the bearing component 2, i.e., under the spray nozzles 10-1, 10-2, 10-3, 10-4, a basin 18 may be arranged for collecting excess black oxide fluid which drips down from the bearing component 2. The basin 18 may be connected via a pipe 16 to the tank 14 for reusing the black oxide fluid. Alternatively, the collected black oxide fluid may be disposed of.

The basin 18 may be connected to side walls 20 for forming a container for collecting excess black oxide fluid. Black oxide fluid which is sprayed onto the bearing component 2 may impact on the side walls 20 and run down the side walls and be collected in the basin 18 or it may be disposed of.

The illustrated apparatus 1 may be scaled to any size and form of bearing component 2. As can easily be seen, the elements of the apparatus 1 may be adapted according to the size of the bearing component 2, for example the holding elements 4-1, 4-2, 4-3, 4-4 may be moved closer together or further apart for accommodating larger or smaller sized bearing components 2.

In summary, the described apparatus provides the advantage of black oxide finishing a bearing component, in particular a bearing component having a large diameter of more than 2.5 m, without the need of several large tanks containing black oxide fluid. Further, as the black oxide fluid does not need to be heated to compensate for a temperature drop due to the heating of the bearing component via the black oxide fluid, the apparatus may improve efficiency and save energy compared with conventional black oxide finishing apparatuses.

### REFERENCE NUMERALS

1 apparatus
2 bearing component
4-1, 4-2, 4-3, 4-4 holding device/elements
6-1, 6-2, 6-3, 6-4 inductor/induction heating device
8 spraying device
10-1, 10-2, 10-3, 10-4 spray nozzles
12 pipe
14 tank
16 pipe
18 basin
20 side walls

What is claimed is:

1. An apparatus for black oxide finishing a bearing component, comprising:
a holder configured to hold the bearing component,
an induction heater having at least one inductor, and
a sprayer,
wherein the at least one inductor is configured to heat the bearing component while the bearing component is held by the holder, and
wherein the spraying device is configured to spray black oxide fluid onto the heated bearing component while the heated bearing component is held by the holder.

2. The apparatus according to claim 1,
wherein the bearing component is a bearing ring.

3. The apparatus according to claim 2,
wherein the holder is configured to rotate the bearing ring relative to the at least one inductor and the sprayer.

4. The apparatus according to any claim 3,
including a collecting basin is arranged below the sprayer configured to collect the black oxide fluid after the black oxide fluid has been sprayed onto the heated bearing ring.

5. The apparatus according to claim 3,
wherein the holder, the sprayer and the induction heating device are arranged above or within a container, the container being configured to collect the black oxide fluid after the black oxide fluid has been sprayed onto the heated bearing ring.

6. The apparatus according to claim 3,
wherein the sprayer comprises at least one spray nozzle configured to provide a jet of black oxide fluid for wetting the entire bearing ring or for wetting a surface of the bearing ring.

7. The apparatus according to claim 3, wherein the sprayer is configured to produce a sheet of the black oxide fluid, and
wherein the holder is configured to move the bearing ring through the sheet of the black oxide fluid.

8. The apparatus according to claim 6,
wherein the at least one inductor is arranged before the at least one spray nozzle in a rotation direction of the bearing ring such that the bearing ring is heated before the black oxide fluid is sprayed onto the bearing ring.

9. The apparatus according to claim 6,
wherein the at least one spray nozzle comprises a plurality of spray nozzles arranged around the bearing ring.

10. The apparatus according to claim 6,
wherein the inductor includes a portion shaped to conform to a portion of the bearing ring.

11. A method for black oxide finishing a bearing a bearing ring, the method comprising
supporting and rotating the bearing ring, and
inductively heating the bearing ring while rotating the bearing ring and applying a black oxide fluid onto the inductively heated bearing ring to form a black oxide coating on the inductively heated bearing ring.

12. The method according to claim 11,
wherein applying the black oxide fluid onto the inductively heated bearing ring comprise producing a sheet of the black oxide fluid and rotating a portion of the bearing ring through the sheet of the black oxide fluid.

13. The method according to claim 11,
wherein applying the black oxide fluid onto the inductively heated bearing ring comprises applying the black oxide fluid onto the inductively heated bearing ring while rotating the bearing ring.
